(19) United States
(12) Patent Application Publication
(10) Pub. No.: US 2015/0199535 A1
(43) Pub. Date: Jul. 16, 2015

(54) ORGANIZATION-BASED POLICIES

(71) Applicant: Oracle International Corporation, Redwood Shores, CA (US)

(72) Inventors: Gregory Alan Wilson, Austin, TX (US); Achyut Ramchandra Jagtap, Sunnyvale, CA (US); Jyoti Arora, Delhi (IN)

(21) Appl. No.: 14/594,866

(22) Filed: Jan. 12, 2015

Related U.S. Application Data
(60) Provisional application No. 61/926,844, filed on Jan. 13, 2014.

(51) Int. Cl. G06F 21/62; H04L 29/06; G06F 17/30

(52) U.S. Cl. CPC G06F 21/6218; G06F 17/30312; H04L 63/20

(57) ABSTRACT

Techniques for representating, managing and storing data related to an organization are provided. An identity management system is disclosed that is configured to manage, represent and store data related to an organization. The identity management system reads data pertaining to an organization from a directory and generates a data model of the organization. The identity management system performs operations to manage the data related to an organization using the data model. The operations include adding logical organizations to the data model and defining user-membership policies associated with entities and logical organizations in the data model. The operations may further include identifying policies to be applied to the users of the organization. In some embodiments, the operations include re-assigning a logical organization and its associated user membership policies to different entities within in the data model while maintaining user-membership policies associated with the logical organization.

### CROSS-REFERENCES TO RELATED APPLICATIONS

This application claims priority under 35 U.S.C. §119(e) to U.S. Provisional Patent Application No. 61/926,844, filed on Jan. 13, 2014, entitled “Organization-based Policies,” the disclosure of which is hereby incorporated by reference in its entirely for all purposes. This application is also related in subject matter to, and incorporates herein by reference in its entirety co-pending U.S. Patent Application No.______, filed concurrently herewith, entitled, “Logical and Physical Organization Management” (Attorney Docket No. 88325-909158 (145800US).

### BACKGROUND

Data pertaining to organizations are typically defined by a specific structure and hierarchy. The structure of an organization generally defines the allocation of different functions and processes to different entites within the organization. These entites may include, for example, enterprises, companies, departments or teams within the organization.

One example of representing the structure of an organization may include representing data pertaining to the organization as a directory information tree (DIT) structure. For example, the DIT structure may organize data pertaining to the organization, hierarchically, by group, by people, by departments or by geographical location.

As an organization grows in size, more and more users and entites may be added to the organization. Representing these additional users, entities and their relationships may involve extending the directory structure of the organization and provisioning additional resources to store information related to the additional users and entities. It is desirable to perform the efficient representation, management and storage of data in an organization. In addition, different entities of an organization may be defined by different policies, work flows and objectives. It is desirable to perform the efficient management of policies associated with different entites of the organization.

### BRIEF SUMMARY

In certain embodiments, techniques are provided (e.g., a method, a system, non-transitory computer-readable medium storing code or instructions executable by one or more processors) for managing, representing, and storing data related to an organization. In one embodiment, an identity management system is disclosed. The identity management system reads data pertaining to an organization from a directory and generates a data model of the organization. For example, a master organization may be represented originally in data structures maintained by an un-migrated client system. This master organization may include hierarchically related entities. Such entities may be sub-organizations of other sub-organizations in the master organization.

When the information in these data structures is migrated to an identity management system, a corresponding physical organization may be created in the identity management system for each sub-organization in the master organization. Thus, a physical organization is a sub-organization in the post-migration identity management system that has an analogue in the client's pre-migration system. Additionally, logical organizations can be added, manually or automatically, to the master organization represented in the identity management system. Thus, a logical organization is a sub-organization that is found in the post-migration identity management system but has no analogue in the client's pre-migration system. In some embodiments, no effort is made to synchronize logical organizations from the identity management system into the client's pre-migration system.

In accordance with at least one embodiment, the identity management system may be configured to manage, represent, and store data related to an organization. Data related to an organization may include, for example, information related to one or more entities within the organization, information related to users in the organization, information related to policies associated with the organization, and so on.

In certain embodiments, the identity management system may be configured to perform operations to read data stored in a directory of an organization and generate a data model of the organization. In some embodiments, the generated data model may identify relationships between various entities of the organization. In some embodiments, the data model may be represented as a hierarchical tree of nodes, in which the nodes of the tree may represent the various entities of the organization.

In accordance with some embodiments, the identity management system may be configured to perform one or more operations to manage data related to the organization using the generated data model. In some examples, the operations may include adding logical organizations to the data model. A logical organization described herein may represent an entity (e.g., sub-organization) of the organization that might not be identified by an enterprise associated with the organization and/or might not be represented in the directory of the organization.

In certain embodiments, the operations performed by the identity management system may include identifying users of the organization and adding the users to an entity (e.g., a physical organization) and/or a logical organization represented by the data model. The operations performed by the identity management system may also include removing users from a physical and/or a logical organization represented by the data model. In some examples, the addition and/or removal of users by the identity management system may be performed based at least in part on the users satisfying one or more user-membership policies. In certain examples, the user-membership policies may define a set of rules that specify the assignment and/or membership of the users to a physical organization and/or a logical organization.

In certain embodiments, the operations performed by the identity management system include re-assigning a logical organization to (e.g., as a sub-organization of) a different physical organization and/or a different logical organization represented in the data model while maintaining the user-membership policies in association with the re-assigned logical organization. In certain examples, the operations performed by the identity management system may include removing a logical organization from the data model. In accordance with at least some examples, the operations performed by the identity management system may include identifying policies to be applied to users of the organization when conflicting policies exist in the organization. As an example, a conflicting policy may exist in an organization when a particular policy is applicable to more than one physical organization within the organization.

### BRIEF DESCRIPTION OF THE DRAWINGS

FIG. 1 depicts aspects of an example system architecture for managing data related to an organization in accordance with at least one embodiment of the present disclosure.

FIG. 2 is an example environment depicting exemplary operations performed by an identity management system to manage data related to an organization, in accordance with one embodiment of the present disclosure.

FIG. 3 depicts aspects of an example system architecture in accordance with at least one embodiment of the present disclosure.

FIG. 4 depicts exemplary operations performed by an identity management system on a data model of the organization, in accordance with at least one embodiment of the present disclosure.

FIG. 5 depicts exemplary operations performed by an identity management system on a data model of the organization, in accordance with at least one embodiment of the present disclosure.

FIG. 6 depicts exemplary operations performed by an identity management system on a data model of the organization, in accordance with at least one embodiment of the present disclosure.

FIG. 7 depicts exemplary operations performed by an identity management system on a data model of the organization, in accordance with at least one embodiment of the present disclosure.

FIG. 8 depicts exemplary operations performed by an identity management system to identify policies of an organization, in accordance with one embodiment of the present disclosure.

FIG. 9 depicts exemplary operations performed by an identity management system to identify policies of an organization, in accordance with one embodiment of the present disclosure.

FIG. 10 is a high level flowchart depicting a process for managing data related to an organization, in accordance with one embodiment of the present disclosure.

FIG. 11 is a high level flowchart depicting a process for managing data related to an organization, in accordance with one embodiment of the present disclosure.

FIG. 12 is a high level flowchart depicting a process for managing data related to an organization, in accordance with one embodiment of the present disclosure.

FIG. 13 is a high level flowchart depicting a process for identifying policies to be applied to users of an organization, in accordance with one embodiment of the present disclosure.

FIG. 14 depicts a simplified diagram of a distributed system for implementing an embodiment.

FIG. 15 is a simplified block diagram of one or more components of a system environment in which services may be offered as cloud services, in accordance with an embodiment of the present disclosure.

FIG. 16 illustrates an exemplary computer system that may be used to implement an embodiment of the present invention.

### DETAILED DESCRIPTION

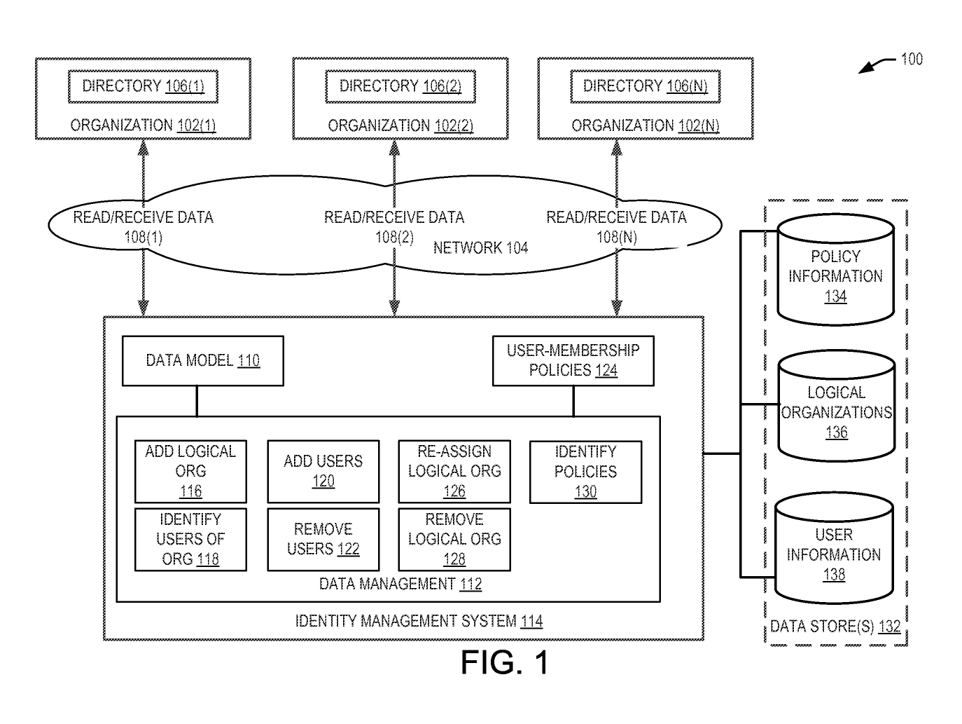

FIG. 1 depicts aspects of an example system architecture 100 for managing data related to an organization in accordance with at least one embodiment of the present disclosure. The architecture 100 includes an identity management system 114 communicatively connected to one or more organizations 102(1) . . . 102(N) (collectively, organizations 102) via a network 104. In some examples, the network 104 may include any one or a combination of many different types of networks, such as cable networks, the Internet, wireless networks, cellular networks and other private and/or public networks.

In accordance with at least one embodiment, the identity management system 114 may be configured to manage, represent and store data related to the organizations 102. Data related to the organizations 102 may include, for example, information related to one or more entities within the organizations, information related to users in the organizations, information related to policies associated with the organizations, and so on. Policies related to the organizations 102 may include, for example, user-membership policies that define the organization's user's memberships in different entities within the organization. In some examples, policies related to the organizations 102 may also include organization-specific policies such as password policies, user generation policies, email generation policies, and the like. In some examples, the entities within the organizations 102 may correspond to various sub-organizations within the organizations 102. In one embodiment, these sub-organizations may be referred to herein as physical organizations.

In certain embodiments, data related to one or more entities of the organizations 102 may be stored in one or more directories, 106(1) . . . 106(N) (collectively directories 106). In one embodiment, the directories 106 may comprise a central repository configured to store information about the organizations such as the users of the organizations, sub-organizations of the organizations, policies by which the users may access resources within the organizations, and the like. In one embodiment, the directories 106 may be implemented as a Lightweight Directory Access Protocol (LDAP) directory. In one example, the LDAP directory may be represented as a hierarchical directory information tree (DIT) structure, in which the nodes of the tree may represent various entities (e.g., physical organizations) within the organization. As an example, if a root node of the tree represents a root organization (e.g., ‘MyCompany.com’), its leaf nodes may represent various physical organizations under the root organization such as ‘Employees,’ ‘Contractors,’ Customers,' and so on.

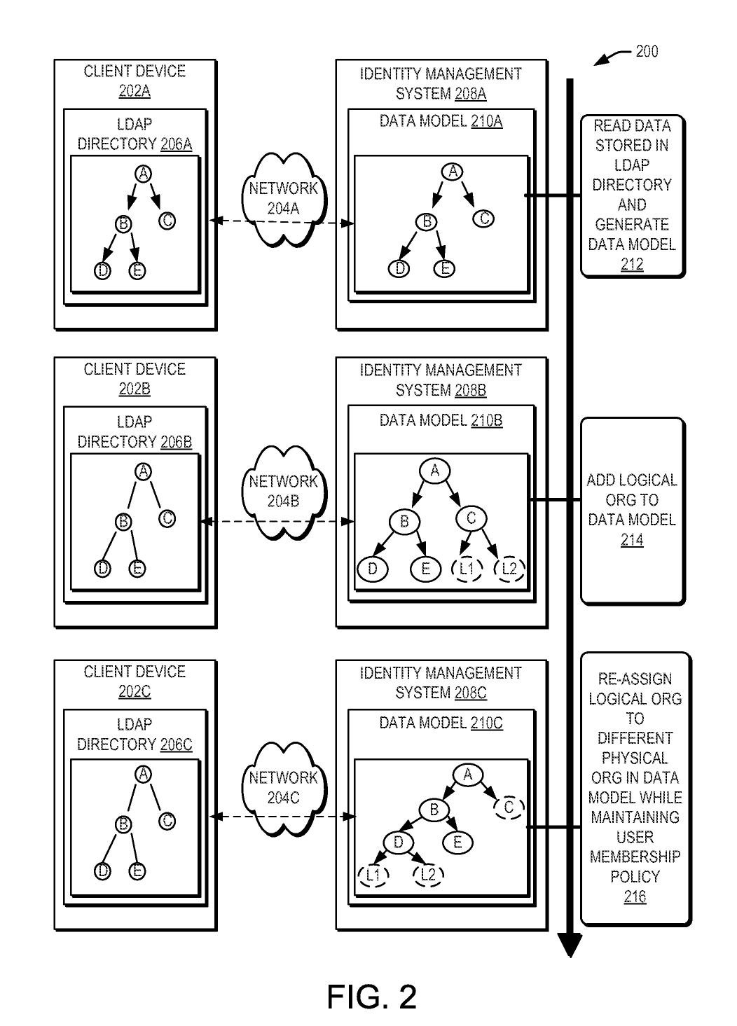

In certain embodiments, the identity management system 114 may be configured to perform one or more operations to receive, identify, or otherwise read data 108(1) . . . 108(N) (collectively, data 108) stored in the directory 106 and generate a data model 110 of an organization 102. In one embodiment, the generated data model 110 may identify relationships (e.g., parent-child relationships) between the various entities (e.g., physical organizations) of the organization 102. In some embodiments, the data model 110 may be represented as a hierarchical tree of nodes, in which the nodes of the tree may represent various physical organizations of the organization 102. An exemplary illustration of a directory structure of an organization and a corresponding data model of the organization generated by the identity management system 114 is illustrated in FIG. 2, described herein.

In accordance with some embodiments, the identity management system 114 may be configured to perform one or more operations to manage data related to the organization 102 using the generated data model 118. In one example, these data management operations 112 may include adding one or more logical organizations 116 to the data model 110. A logical organization described herein may represent an entity (e.g., sub-organization) of the organization 102 that might not be identified by an enterprise associated with the organization 102 and/or might not be represented in the directory 106 of the organization.

As an example, an administrator of the organization 102 may wish to delegate the administration of a particular physical organization (e.g., ‘Contractors’) to one or more sub-organizations within the organization. In one embodiment, the identity management system 114 may be configured to add one or more logical organizations to the generated data model to represent these sub-organizations. As an example, the identity management system 114 may be configured to add logical organizations (e.g., ‘East-coast contractors’ and ‘West-coast contractors’) to the physical organization (Contractors') in the generated data model. The generation of the data model 110 and the addition of logical organizations to the data model 110 by the identity management system 114 described herein provides for the efficient management, representation, and storage of data pertaining to the organization. By adding logical organizations to the data model 110, the directory 106 of the organization does not need to be modified and/or extended to represent these additional sub-organizations. In addition, the organization 102 does not need to provision additional resources such as storage capacity to store information pertaining to these sub-organizations.

In certain embodiments, the operations performed by the identity management system 114 may include identifying users 118 of the organization 102 and adding users 120 to a physical and/or a logical organization represented by the data model 118. The operations performed by the identity management system 114 may also include removing users 122 from a physical and/or a logical organization represented by the data model 118. In some examples, the addition and/or removal of users by the identity management system 114 may be performed based at least in part on the users satisfying one or more user-membership policies 124. In certain examples, the user-membership policies 124 may define a set of rules that specify the assignment and/or membership of users to a physical organization and/or a logical organization. As an example, a user-membership policy may specify that users under the ‘Contractors’ organization be automatically assigned to the ‘Employees’ organization when the users under the ‘Contractors’ organization satisfy one or more user-membership policies.

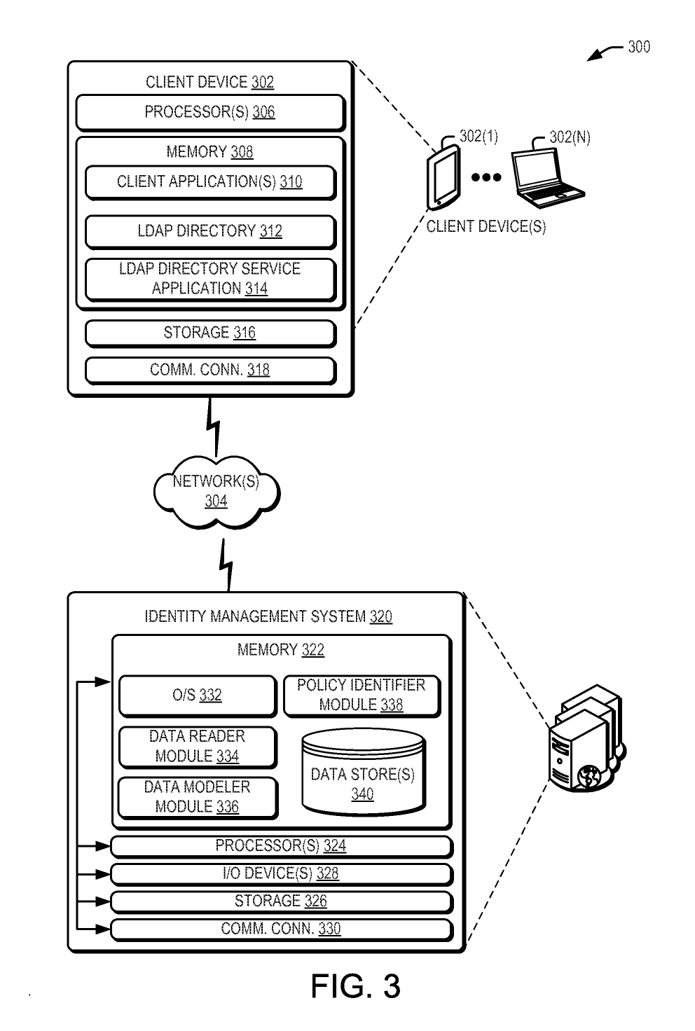

In some examples, the operations performed by the identity management system 114 may include re-assigning a logical organization 126 to a different physical organization and/or a different logical organization represented in the data model while maintaining the user-membership policies 124 in association with the removed logical organization. In certain examples, the operations performed by the identity management system 114 may include removing a logical organization 128 from the data model 110. In accordance with at least some examples, the operations performed by the identity management system 114 may include identifying policies 130 to be applied to users of the organization 102, when conflicting policies exist in the organization 102. As an example, a conflicting policy may exist in an organization when a particular policy is applicable to more than one physical organization within the organization. The operations performed by the identity management system 114 are discussed in detail with reference to FIGS. 2 and 3.

In some embodiments, the identity management system 114 may include one or more data stores 132. The data stores 132 may be configured to provide a storage repository for storing information pertaining to data related to the organizations 102. In some examples, the data stores 132 may include a policy information data store 134, a logical organizations data store 136 and a user information data store 138. The policy information store 134 may be configured to store information related to policies of the organization 102. These policies may include, for example, user-membership policies that define the membership of users to a physical organization and/or a logical organization. The policies may also include, for example, policies specific to the organization such as password policies, email generation policies, user-registration policies and the like.

In some examples, the logical organizations data store 136 may be configured to store information related to the logical organizations represented in the data model. Such information may include, for example, information related to the users assigned to the logical organization, information related to user-membership policies associated with the logical organization, information related to organization-specific policies defined for the logical organization, and the like. In certain embodiments, logical organization data store 136 may be configured to store an organization identifier for each logical organization. The organization identifier may be a pointer to a parent organization of the logical organization. The parent organization may be another logical organization or a physical organization represented in the data model.

In some examples, the user information data store 138 may be configured to store information related to users of the organization such as user accounts, applications (e.g., an email application, an internet application, and so on) that the users of a physical organization and/or a logical organization may access, usage rights to access these applications, access policies, access privileges to access functionality or capabilities afforded by the applications, and so on.

FIG. 2 is an example environment 200 depicting exemplary operations performed by an identity management system to manage data related to an organization, in accordance with one embodiment of the present disclosure. In one example, the environment 200 includes a client device, 202A, 202B or 202C (collectively, client device 202) communicatively coupled to an identity management system, 208A, 208B or 208C(collectively, identity management system 208) via a network, 204A, 204B or 204C (collectively, network 0204). The network 204 may be the same or similar to the network 104 described in FIG. 1. The client device 202 may be any type of computing device such as, but not limited to, a mobile phone, a smart phone, a personal digital assistant (PDA), a laptop computer, a desktop computer, a thin-client device, a tablet PC, and the like.

In one embodiment, the client device 202 may include one or more modules configured to store and manage information about users of an organization (e.g., organization 102), described herein. These modules may be implemented in hardware, software, or a combination thereof. In some embodiments, the client device 202 may be configured to request services, such as data management services, from the identity management system 208, described herein. The modules of the client device 202 and the operations performed by the client device 202 are discussed in detail in relation to FIG. 3.

In some examples, the identity management system 208 may be implemented as any type of computing device such as, but not limited to, a mobile device, a desktop, thin-client, and/or cloud computing devices, such as servers. In one embodiment, the identity management system 208 may include one or more servers configured to perform or otherwise host features described herein including, but not limited to, the management of data related to an organization.

In accordance with at least one set of operations 212, the identity management system 208 may be configured to read data stored in an LDAP directory, 206A, 206B or 206C (collectively, directory 206) in the client device 202 and generate a data model, 210A, 210B or 210C (collectively, data model 210) corresponding to the data stored in the directory 206. In accordance with another set of operations 214, the identity management system 208 may be configured to add one or more logical organizations that are not represented in the directory 206 of the client device 202 to the data model 210. The operations 214, in some examples, may also include adding users into a logical organization and defining user-membership policies associated with the logical organization. In some embodiments, the identity management system 208 may also be configured to perform one or more operations 216 to re-assign a logical organization and its associated user membership policies to a different physical organization and/or a different logical organization in the data model 210 when a physical organization and/or a logical organization is deleted from the directory in the client device 202. In other embodiments, the identity management system 208 may be configured to perform one or more operations to remove a logical organization from the data model and re-assign the logical organization to a different physical organization and/or a different logical organization represented in the data model while maintaining the user-membership policies in association with the removed logical organization. The operations performed by the identity management system are discussed in detail in relation to FIG. 2.

FIG. 3 depicts aspects of an example system architecture 300 in accordance with at least one embodiment of the present disclosure. In architecture 300, one or more client devices such as computing devices 302(1)-(N) (collectively, client devices 302) may access an identity management system 320 via one or more networks 304. Client devices 302 may be the same or similar to the client device 202 discussed in relation to FIG. 2. In some aspects, the identity management system 308 may be configured to access or otherwise manage data related to an organization, stored in the client device 302, described herein.

In one illustrative configuration, the client device 302 may include at least one memory 308 and one or more processing units (or processor(s)) 306. The processor(s) 306 may be implemented as appropriate in hardware, computer-executable instructions, firmware, or combinations thereof. Computer-executable instruction or firmware implementations of the processor(s) 306 may include computer-executable or machine-executable instructions written in any suitable programming language to perform the various functions described.

The memory 308 may store program instructions that are loadable and executable on the processor(s) 306, as well as data generated during the execution of these programs. The memory 308 may be volatile (such as random access memory (RAM)) and/or non-volatile (such as read-only memory (ROM), flash memory, etc.). The client device 302 may also include additional storage 316, which may include removable storage and/or non-removable storage. The additional storage 316 may include, but is not limited to, magnetic storage, optical disks, and/or tape storage. The disk drives and their associated computer-readable media may provide non-volatile storage of computer-readable instructions, data structures, program modules, and other data for the computing devices. In some implementations, the memory 308 may include multiple different types of memory, such as static random access memory (SRAM), dynamic random access memory (DRAM), or ROM.

The memory 308, the additional storage 316, both removable and non-removable, are all examples of computer-readable storage media. For example, computer-readable storage media may include volatile or non-volatile, removable or non-removable media implemented in any method or technology for storage of information such as computer-readable instructions, data structures, program modules, or other data. The memory 308 and the additional storage 316 are all examples of computer storage media.

The client device 302 may also include communications connection(s) 318 that allow the client device 302 to communicate with a stored database, the identity management system 320, another computing device or server, user terminals, and/or other devices via the networks 304. The client device 302 may also include input/output (I/O) device(s), such as a keyboard, a mouse, a pen, a voice input device, a touch input device, a display, one or more speakers, a printer, etc.

Turning to the contents of the memory 308 in more detail, the memory 308 may include an operating system and one or more application programs or services for implementing the features disclosed herein. In the illustrated embodiment, the memory 308 includes one or more client application(s) 310, an LDAP directory 312 and an LDAP directory service application 314. In some examples, the client applications 310 may include email applications, internet applications, database applications and the like that are installed on the client device 302.

In one embodiment, the directory 312 in the client device 102 may be a repository configured to store information about users of the organization, sub-organizations (also referred to as physical organizations herein) within the organization, policies by which users may access resources within the organization, and so on. In one embodiment, as discussed in relation to FIG. 1, the directory 312 may be implemented as an LDAP directory. In one example, the LDAP directory 312 may be represented as a hierarchical directory information tree (DIT) structure, in which the nodes of the tree represent various physical organizations within the organization.

In certain embodiments, the nodes of the DIT structure may also include information pertaining to one or more users of the organization. In some examples, this information may include attributes such as the name of the user, the email address of the user, the status of the user (i.e., full-time, part-time, contractor), the name of the physical organization that the user is assigned to, the name of the user's supervisor within the physical organization, and the like. In one embodiment, the assignment of users to nodes in the hierarchical DIT structure may be performed manually. For example, an administrator of the organization may manually perform the assignment of users to a node, based at least in part on the attributes of the users. As an example, an administrator may manually assign a user to a physical organization (Employee') if an attribute (e.g., ‘Status’) related to the user is ‘Full Time.’ In some embodiments, users that are manually assigned to nodes in the DIT structure may be referred to herein as ‘static users.’

In some embodiments, the assignment of users to nodes in the DIT structure may be performed automatically by one or more software modules in the client device 302, based on the users satisfying one or more user-membership rules. Such users may be referred to herein as ‘dynamic users.’ In certain examples, the user-membership rules may refer to a set of rules that define the assignment of users to a physical organization within the organization. As an example, a user-membership rule may specify that a user should be assigned to the ‘Employee’ physical organization if an attribute (e.g., ‘Status’) related to the user is ‘Full Time’.

In accordance with at least some embodiments, the client device 302 may include an LDAP directory service application 314. The LDAP directory service application 314 may be configured to define a set of protocols by which data stored in the directory 312 may be accessed and/or managed by the client application(s) 310 in the client device 302. As an example, the client application(s) 310 (e.g., an email application) may utilize the LDAP directory service application 314 to look up the email address of a user in the organization. In other examples, the LDAP directory service application 314 may be configured to perform other operations for the client application(s) 310. As an example, the LDAP directory service application 314 may perform a query operation to enable the client applications(s) 310 to look up information about a user in the directory 312. In other examples, the LDAP directory service application 314 may perform a search operation to enable the client applications(s) 310 to designate queries to search for data within the directory 312. In some examples, the LDAP directory service application 314 may perform a modification operation to enable the client applications(s) 310 to change information in the directory 312 such as the name of an entry in the directory, or move the entry to a different location in the directory.

In some embodiments, the client device 302 may communicate with the identity management system 320 to utilize one or more services provided by identity management system 320, described herein. In one embodiment, the services provided by the identity management system 320 may include the representation, management, and storage of data related to organizations that may be managed, hosted or provided by the client device 302, described herein. In one illustrative configuration, the identity management system 320 may include at least one memory 322 one or more processing units (or processor(s)) 324 and storage 326. The memory 322, the processor(s) 324 and storage 326 may be implemented in a same or similar manner to the memory 308, processor(s) 306 and storage 316 described in relation to client device 302.

Turning to the contents of the memory 322 in more detail, the memory 322 may include an operating system 332 and one or more application programs or services for implementing the features disclosed herein. In the illustrated embodiment, the memory 322 includes a data reader module 334, a data modeler module 336, a policy identifier module 338 and one or more data stores 340.

In various embodiments, and as will be discussed in detail below, the modules 334, 336, and 338 and the data store(s) 340 may be configured to perform functionality that enables the representation, management and storage of data related to an organization, stored in the directory of the client device 302. These modules may be implemented in hardware, or software, or combinations thereof. The various modules depicted in FIG. 3 are meant for illustrative purposes and are not intended to limit the scope of embodiments of the present invention. Alternative embodiments may include more or fewer modules than those shown in FIG. 3.

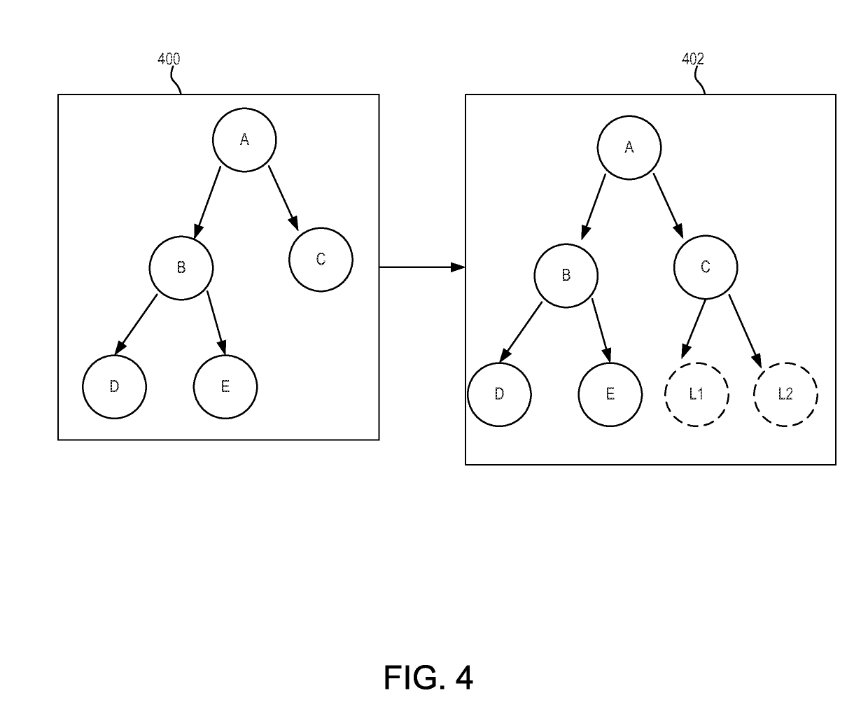

In accordance with at least one embodiment, the data reader module 334 may be configured to receive, identify, or otherwise read data stored in the directory 312 of the client device 302. In accordance with at least one embodiment, the data modeler module 336 may be configured to process the data from the data reader module 334 to identify one or more physical organizations, identify relationships (e.g., parent-child relationships) between the physical organizations and generate a data model (e.g., data model 110, 210), based at least in part on the identified physical organizations and the identified relationships. In one embodiment, and as discussed in relation to FIG. 1 and FIG. 2, the data model may be represented as a hierarchical tree of nodes, in which the nodes may represent the various physical organizations in the organization. An exemplary illustration of a directory structure of an organization and a corresponding data model of the organization generated by the identity management system is illustrated in FIGS. 4-7, described herein.

In some embodiments, the data modeler module 336 may be configured to assign one or more users to a physical organization represented in the data model. In one embodiment, the assignment of users to a physical organization in the data model may be performed based on identifying if the user is a ‘static user’ or a ‘dynamic user.’ In one example, if the user has been identified as a ‘static user’ in the directory 312 of the client device 302, then the data modeler module 336 may be configured to assign the user as a ‘static user’ in the generated data model. Similarly, if the user has been identified as a ‘dynamic user’ in the directory 312 of the client device 302, then the data modeler module 336 may be configured to assign the user as a ‘dynamic user’ in the generated data model.

In certain embodiments, data modeler module 336 may be configured to associate one or more policies to a physical organization represented in the generated data model. These policies may include, for example, user-membership policies that define the membership of users to the physical organization. The policies may also include, for example, policies specific to the organization such as password policies, email generation policies, user-registration policies and the like. In one embodiment, these policies may be stored in the data stores 340. In some embodiments, these policies may be defined by the identity management system 320 and stored in the data stores 340. In other embodiments, the identity management system 320 may also be configured to receive, identify, or otherwise obtain information associated with the policies from the client device 302.

In some embodiments, the data modeler module 336 may be configured to add one or more logical organizations to the generated data model and add one or more users to the logical organizations. In one embodiment, the users may be manually to the logical organizations, for example, by an administrator of the identity management system. In other embodiments, the data modeler module 336 may be configured to dynamically assign users to logical organizations, based on the users ratifying one or more user-membership policies.

In other embodiments, data modeler module 336 may be configured to identify and/or associate one or more policies with the logical organization. These policies may include, for example, user-membership policies that define a membership of one or more users of the organization to the logical organization. The policies may also include policies specific to the organization such as password policies, email generation policies, user-registration policies.

In certain embodiments, the services and/or operations performed by identity management system 108 may include adding users to a physical organization and/or a logical organization represented in the data model, removing users from a physical organization and/or a logical organization represented in the data model and re-assigning a logical organization to a different physical organization represented in the data model.

In some embodiments, the data modeler module 336 may be configured to dynamically define user-membership policies by which one or more users may be added to and/or removed from a physical organization and/or a logical organization represented in the data model. As an example, an administrator of the client device 302 may wish to delegate the management of all contractors of the master organization to a different physical organization (e.g., ‘Employee’ organization). In one embodiment, the data modeler module 336 may be configured to dynamically define a user-membership rule that adds the users of the ‘Contractors’ organization to the ‘Employee’ organization represented in the generated data model.

In other embodiments, the data modeler module 336 may be configured to remove one or more users from a physical organization and/or a logical organization represented in the data model. In one embodiment, if the user is a ‘static user’ (i.e., the user was manually added to the physical organization and/or the logical organization), then, an administrator of the identity management system may manually remove the user from the physical organization and/or the logical organization. If the user is a ‘dynamic user’ (i.e., the user was automatically added to the physical organization and/or the logical organization based on the user satisfying a user-membership rule), then the data modeler module 336 may be configured to automatically remove the user from the physical organization and/or the logical organization, for example, when the user ceases to satisfy a user-membership rule.

In other embodiments, the data modeler module 336 may be configured to remove a logical organization from the data model and re-assign the logical organization to a different physical organization and/or a different logical organization represented in the data model while maintaining the user-membership policies in association with the removed logical organization. In some embodiments, the data modeler module 336 may be configured to re-assign a logical organization and its associated user membership policies to a different physical organization represented in the data model when a physical organization is deleted from the directory of the master organization. Thus, the data modeler module 336 may be configured to enable the persistence of user-membership policies associated with a logical organization even when the logical organization is re-assigned to a different physical organization.

In accordance with at least one embodiment, the data stores 340 may be configured to store information related to policies of the organization, information related to logical organizations represented in the data model and information related to the users of the organization. As discussed in relation to FIG. 1, such information may include, for example, user-membership policies that define the membership of users to a physical organization and/or a logical organization, information related to policies specific to the organization such as password policies, email generation policies, user-registration policies and the like, information related to user accounts, applications (e.g., an email application, an internet application and so on) that the users of the logical organization may access, usage rights to access these applications, access policies, access privileges to access functionality or capabilities afforded by the applications and so on.

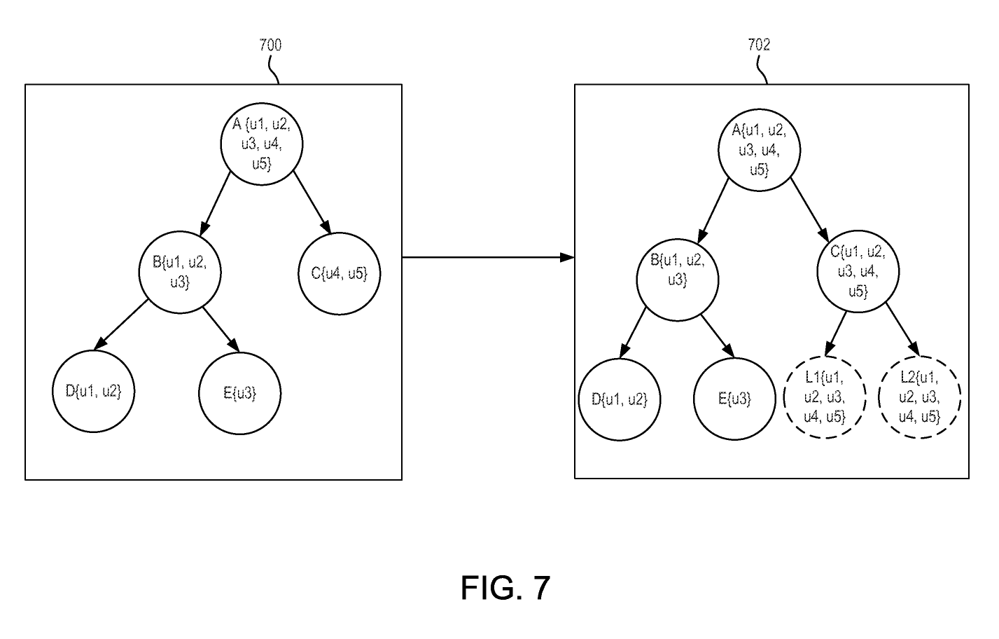

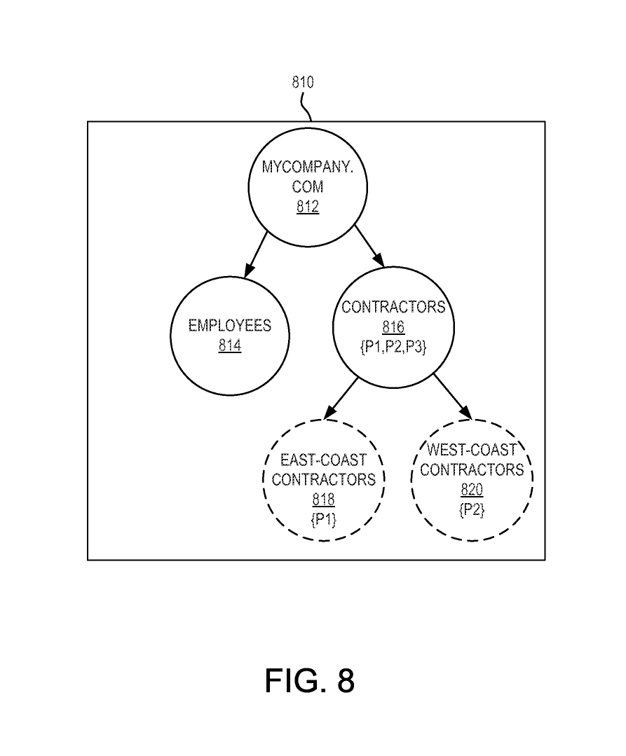

In accordance with at least some embodiments, the identity management system 320 may include a policy identifier module 338. In one embodiment, the policy identifier module 338 may be configured to perform the identification and management of policies for users of the organization represented in the data model. In one embodiment, the policy identifier module 338 may be configured to identify a policy to be applied to a user of the organization, when conflicting policies exist in the organization. As an example, a conflicting policy may exist in an organization when a particular policy can be applied to more than one physical organization and/or a logical organization within the master organization. The operations performed by the policy identifier module 338 are discussed in detail in relation to FIGS. 7 and 8.

FIGS. 4-7 depict exemplary operations performed by an identity management system on a data model of the master organization, described herein. In FIGS. 4-7, structures 400, 500, 600 and 700 represent the directory structure of an organization and structures 402,502, 602 and 702 represent a corresponding data model of the master organization generated by the identity management system (e.g., 114). In the illustrated example, structures 400, 402, 500, 502, 600, 602 and 700, 702 are represented as a hierarchical tree of nodes A, B, C, D and E, in which the nodes represent various physical organizations within the master organization. The various nodes depicted in FIGS. 4-7 are meant for illustrative purposes and are not intended to limit the scope of embodiments of the present invention. Alternative embodiments may include more or fewer nodes than those shown in FIGS. 4-7.

In one embodiment, and as illustrated in FIG. 4, the identity management system may be configured to modify the generated data model 402 of the master organization to include nodes L1 and L2 in which nodes L1 and L2 may represent different logical organizations of the master organization. As discussed above, logical organizations may represent various sub-organizations in the master organization that are not identified in the directory structure 400 of the master organization.

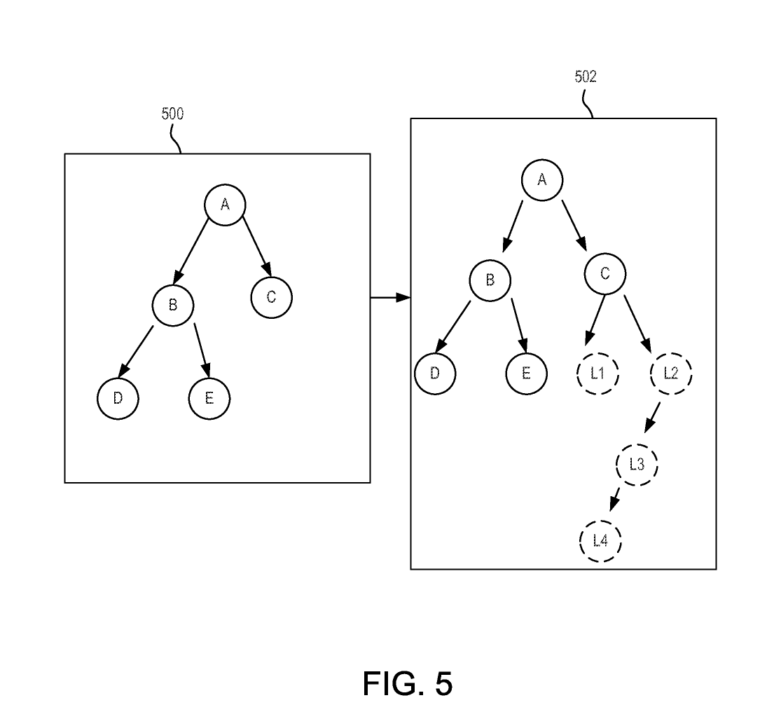

In another embodiment, and as illustrated in FIG. 5, the identity management system may be configured to modify the data model 502 of the master organization to include nodes L1 and L2 and nodes L3 and L4 as children of node L2, in which nodes L1, L2, L3 and L4 may represent logical organizations of the master organization. Thus, in some embodiments, the identity management system may be configured to modify the data model 502 of the master organization to include one or more logical organizations as children of a logical organization.

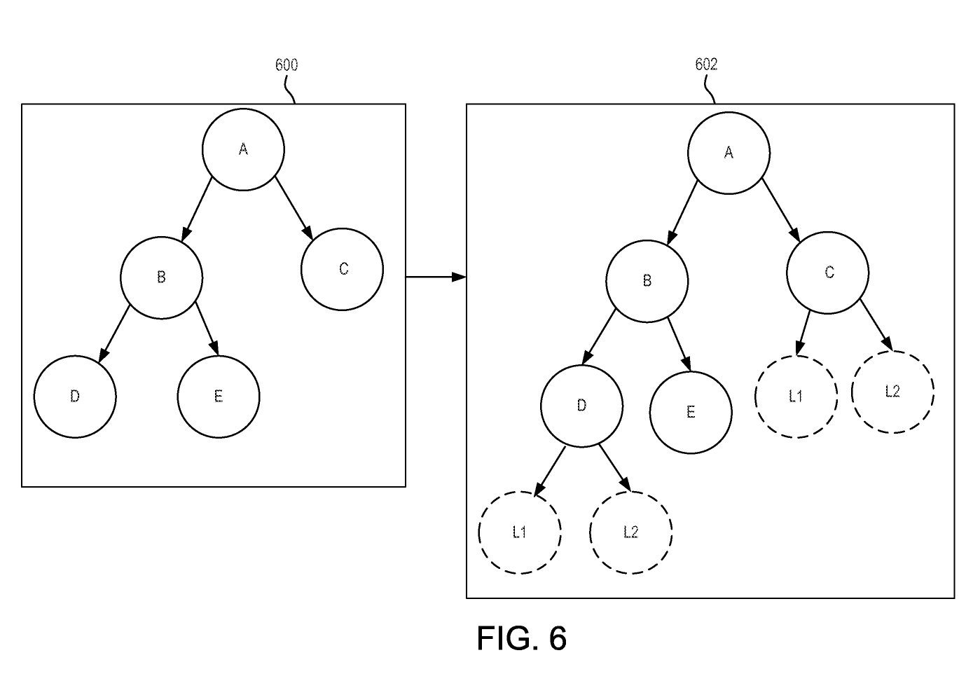

In some embodiments, and as illustrated in FIG. 6, the identity management system may be configured to re-assign one or more logical organizations L1 and L2 to a different physical organization (e.g., D), for example, when a physical organization (e.g., C) is removed from the directory structure 600 of the master organization while maintaining the user-membership rules associated with the logical organizations L1 and L2. Thus, in some embodiments, the identity management system may be configured to enable the persistence of user-membership rules associated with a logical organization even when the logical organization is re-assigned to a different physical organization and/or a different logical organization in the data model.

In certain embodiments and as illustrated in FIG. 7, the identity management system may be configured to modify the data model 702 of the master organization by dynamically assigning one or more users to a physical organization (e.g., C) when the users satisfy a user-membership policy associated with the physical organization. In the illustrated example, the identity management system adds users u1, u2 and u3 to the physical organization C. Similarly, the identity management system may be configured to automatically add the users, u1, u2 and u3 to one or more logical organizations, L1 and L2 which are children of the physical organization C.

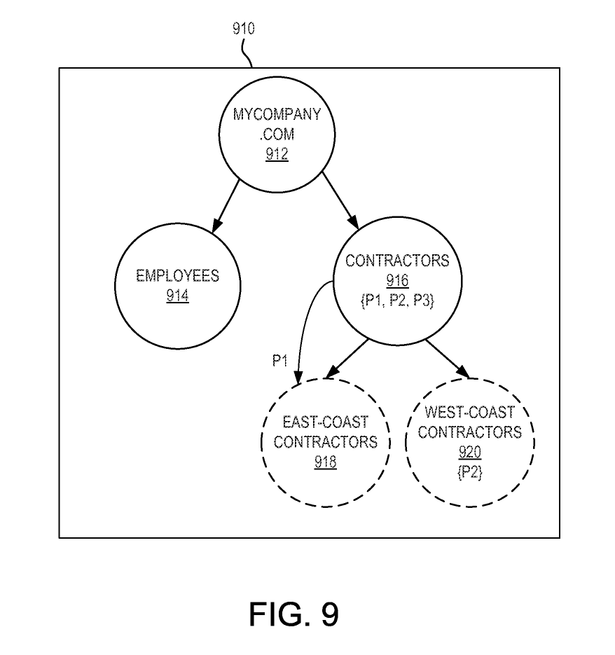

FIGS. 8-9 depict exemplary operations performed by an identity management system to identify policies of an organization, in accordance with one embodiment of the present disclosure. In one embodiment, the operations depicted in FIGS. 8-9 may be performed by the policy identifier module (e.g., 338) in the identity management system 320 shown in FIG. 3.

FIG. 8 is an exemplary illustration of a hierarchical tree represented by a data model generated by the identity management system, described herein. In one embodiment, hierarchical tree 810 may be represented as a hierarchical tree of nodes 812, 814, 816, 818 and 820 in which the nodes represent various physical organizations and/or logical organizations within an organization. In the illustrated example, the root node 812 of the tree 810 may represent a root organization (e.g., ‘MyCompany.com’) and its leaf nodes may represent various physical and/or logical organizations under the root organization such as an ‘Employees’ 814, ‘Contractors’ 816, ‘East-coast Contractors’ 818 and ‘West-coast Contractors’ 820. Policies P1, P2, and P3 may identify various policies associated with nodes 816, 818 and 820 in the tree 810. As discussed in relation to FIGS. 1-3, these policies may include for example, user-membership policies that define a membership of one or more users of the master organization to a physical organization and/or a logical organization. The policies may also include policies specific to the organization such as password policies, email generation policies, user-registration policies.

In one embodiment, the policy identifier module 338 may be configured to identify a policy to be applied to a user of the organization, when an event is detected relative to the user. For example, the policy identifier module 338 may be configured to detect a password change by a user, as an event relative to the user. In one embodiment, upon detecting the password change event, the policy identifier module 338 may be configured to identify the physical and/or logical organization that the user is a member of For example, consider that a user is a member of the logical organization (e.g., ‘East-coast Contractors’). Per the example illustrated in FIG. 8, the logical organization (e.g., ‘East-coast Contractors’) is represented by the leaf node 818 in the hierarchical tree 810.

In accordance with at least some embodiments, the policy identifier module 338 may then be configured to identify if a password policy is associated with the ‘East-coast Contractors’ logical organization. Per the example illustrated in FIG. 8, a password policy P1 may be associated with the leaf node 818. If it is determined that a password policy is associated with the leaf node 818, in certain embodiments, the policy identifier module 338 may then be configured to identify if a password policy is also associated with a parent node (e.g., node 816) associated with leaf node 818 in the hierarchical tree 810. Continuing with the example illustrated in FIG. 8, consider that the password policy P1 is also associated with parent node 816 (i.e., ‘Contractors’). In response to identifying that the password policy P1 is associated with both nodes 816 and 818 in the hierarchical tree, in one embodiment, the policy identifier module 338 may be configured to identify the particular password policy to be applied to the user as follows.

In one embodiment, the policy identifier module 338 may be configured to identify the particular policy to be applied to the user by identifying the password policy P1 associated with the node that is farthest in the path from the root node of the hierarchical tree to the leaf node in the hierarchical tree. Per the above example, the policy identifier module 338 may identify that the password policy P1 is associated with the leaf node 818 that is farthest in the path from the root node 812 in the hierarchical tree 810. In one embodiment, the policy identifier module 338 may then be configured to apply the password policy P1 associated with leaf node 818 to the user. Thus, in this manner, the policy identifier module 338 may be configured to override a policy identified in a parent node (e.g., 816) when a conflicting policy P1 is identified in a leaf node (e.g., 818) of the hierarchical tree.

In accordance with certain examples, upon detecting a password change event from a user as discussed above, if the policy identifier module 338 determines that a policy (e.g., password policy) related to the password change is not associated with any node in the hierarchical tree that the user is a member of, then, in one embodiment, the policy identifier module 338 may be configured to identify if a password policy is associated with a parent node of the leaf node in the hierarchical tree 810 that the user is a member of For example, as shown in FIG. 9, if the policy identifier module 338 determines that a password policy is not identified with a node (e.g., 918) that the user is a member of, in some embodiments, the policy identifier module 338 may then be configured to identify if a password policy (e.g., P1) is associated with the parent node of the node that the user is a member of. In one embodiment, the policy identifier module 338 may be configured to apply the password policy P1 identified by the parent node, to the user. Thus, in some embodiments, the policy identifier module 338 may be configured to identify a particular policy to be applied to a user of an organization by identifying a parent node (e.g., 916) in the hierarchical tree from which a leaf node (e.g., 918) in the hierarchical tree may inherit its policy from. The hierarchical tree 910 represented in FIG. 9 may be similar to the hierarchical tree 810 represented in FIG. 8.

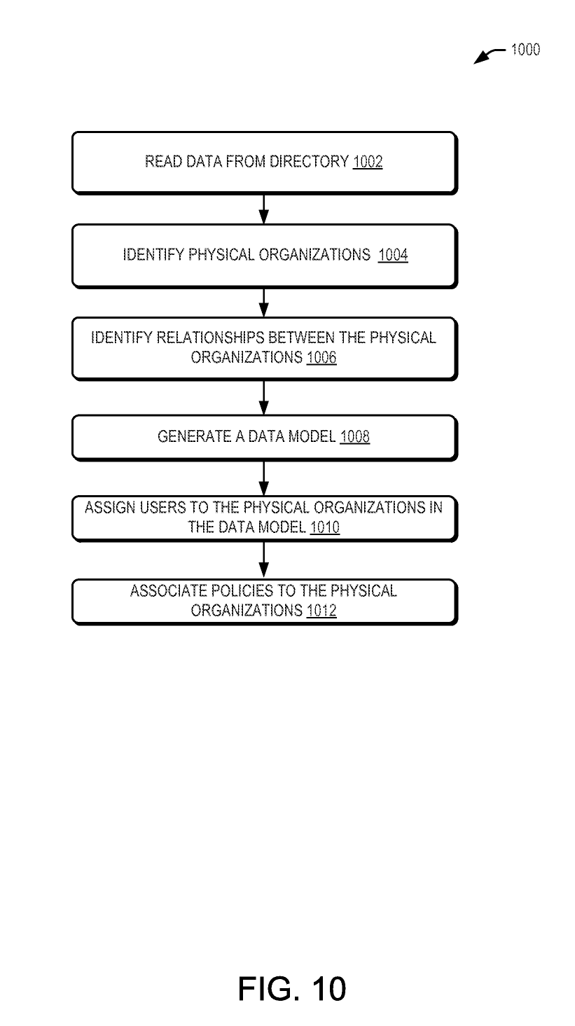

FIGS. 10-12 illustrate example flow diagrams showing respective processes 1000, 1100 and 1200 for performing the management of data related to an organization, described herein. In some examples, the identity management system (e.g., utilizing at least the data reader module 334, the data modeler module 336, the policy identifier module 338 and the data stores 340) shown in FIG. 3 and other figures may perform the processes 1000, 1100 and 1200 of FIGS. 10-12. The processes 1000, 1100 and 1200 are illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable storage medium, for example, in the form of a computer program comprising a plurality of instructions executable by one or more processors. The computer-readable storage medium may be non-transitory.

FIG. 10 is a high level flowchart depicting a process for managing data related to an organization, in accordance with one embodiment of the present disclosure. In some examples, the process 1000 may begin at 1002 by reading data from a directory of an organization. In one example, the directory (e.g., 106, 206) may be stored in a client device (e.g., 202, 302) of the organization. In some examples, the directory may be a repository configured to store information about users of the organization, physical organizations within the organization, policies by which users may access resources within the organization, and so on.

At 1004, the process 1000 may include identifying one or more physical organizations from the data stored in the directory. In some examples, at 1006, the process 1000 may include identifying relationships (e.g., parent-child relationships) between the physical organizations. At 1008, the process 1000 may include generating a data model (e.g., data model 110, 210), based at least in part on the identified physical organizations and the identified relationships.

In certain embodiments, at 1010, the process 1000 may include assigning users to the physical organizations in the data model. In one embodiment, the assignment of users may be performed manually, for example, by an administrator of the identity management system. In other embodiments, the assignment of users may be performed automatically by the identity management system based on the users satisfying one or more user-membership rules.

In certain embodiments, at 1012, the process 1000 may include associating policies to the physical organizations represented in the data model. In some embodiments, the policies may be defined by the identity management system and stored in a policy information datastore (e.g., 134). In other embodiments, the identity management system may be configured to receive, identify, or otherwise obtain information associated with the policies from the client device (e.g., 202, 302). As discussed in relation to FIG. 1, these policies may include, for example, user-membership policies that define a membership of the users to the physical organization. The policies may also include policies specific to the organization such as password policies, email generation policies, user-registration policies and the like.

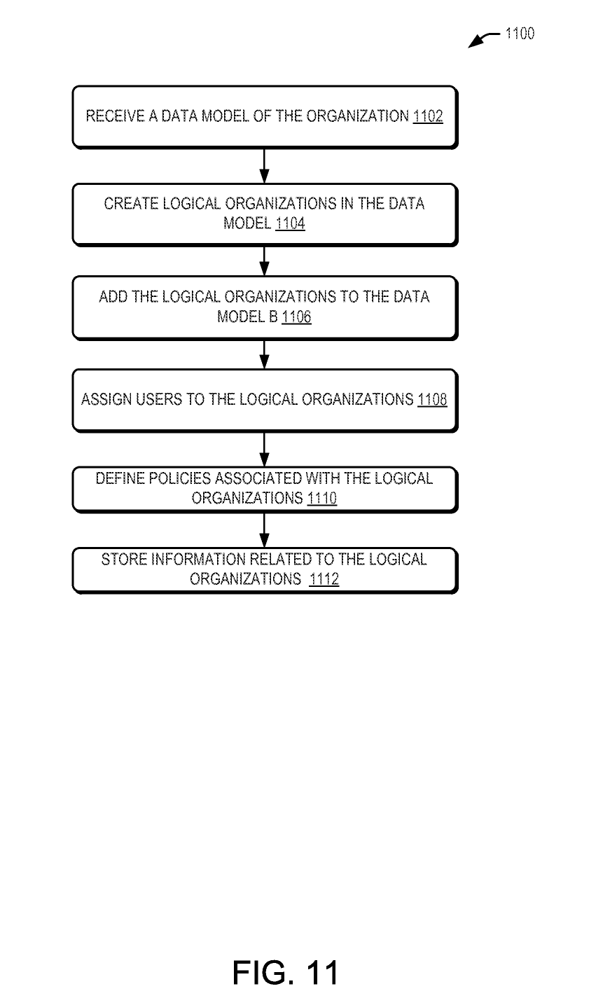

FIG. 11 is a high level flowchart depicting a process for managing data related to an organization, in accordance with one embodiment of the present disclosure. In some examples, the process 1100 may begin at 1102 by receiving a data model of the master organization. In one embodiment, and as discussed above, the identity management system (e.g., 114, 208, 320) may be configured to generate a data model of the master organization by identifying physical organizations in the master organization and identifying relationships between the physical organizations. At 1104, the process 1100 may include creating one or more logical organizations in the generated data model. As an example, and as discussed above, an organization may wish to delegate the administration of a particular physical organization (e.g., ‘Contractors’) to one or more sub-organizations within the master organization. In response, the identity management system (e.g., 114, 208, 320) may be configured to create logical organizations (e.g., ‘East-coast contractors’ and ‘West-coast contractors’) in the data model. At 1106, the process 1100 may include adding the logical organizations to the data model. In some examples, at 1108, the process 1100 may include assigning users to the logical organizations. At 1110, the process 1100 may include associating policies with the logical organizations. In certain embodiments, at 1112, the process 1100 may include storing information related to the logical organizations in a logical organizations data store (e.g., 136).

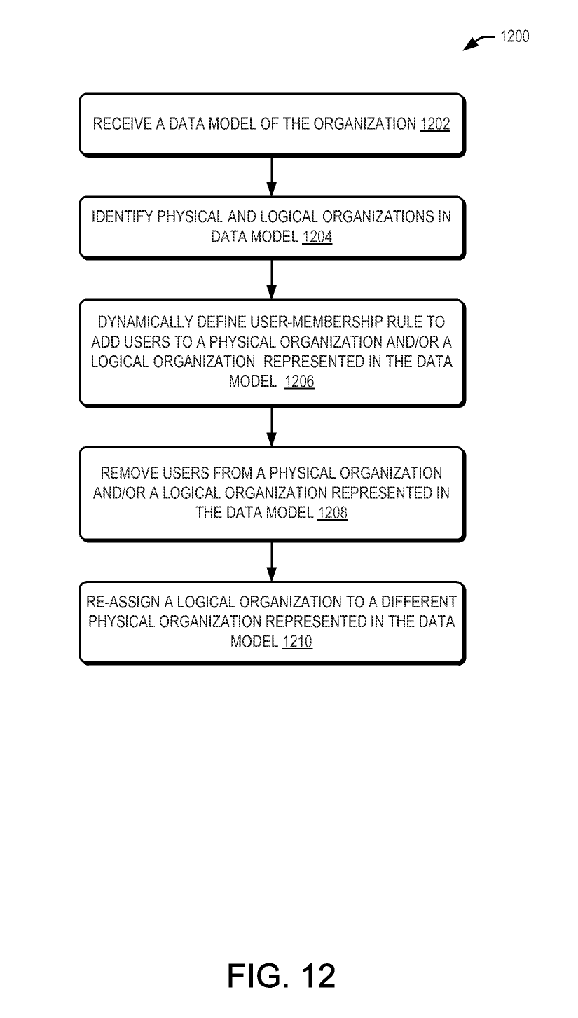

FIG. 12 is a high level flowchart depicting a process for managing data related to an organization, in accordance with one embodiment of the present disclosure. In some examples, the process 1200 may begin at 1202 by receiving a data model of the master organization. At 1204, the process 1200 may include identifying one or more physical organizations and/or one or more logical organizations in the data model. In one embodiment, at 1206, the process 1200 may include dynamically defining a user-membership rule to add one or more users to a physical organization and/or a logical organization represented in the data model. As an example, an administrator of the master organization may wish to delegate the management of all contractors of the master organization to a different physical organization (e.g., ‘Employee’ organization). In one embodiment, the identity management system may be configured to dynamically define a user-membership rule that adds users of the ‘Contractors’ organization to the ‘Employee’ organization in the generated data model.

In some examples, at 1208, the process 1200 may include removing one or more users from a physical organization and/or a logical organization represented in the data model when the user ceases to satisfy the user-membership rule defined by the physical organization and/or a logical organization. In some examples, at 1210, the process 1200 may include to re-assigning a logical organization to a different physical organization represented in the data model. As an example, an organization may wish to remove a physical organization of the master organization. In one embodiment, the identity management system may be configured to re-assign the logical organization to a different physical organization in the master organization while maintaining the user-membership rules associated with the logical organization.

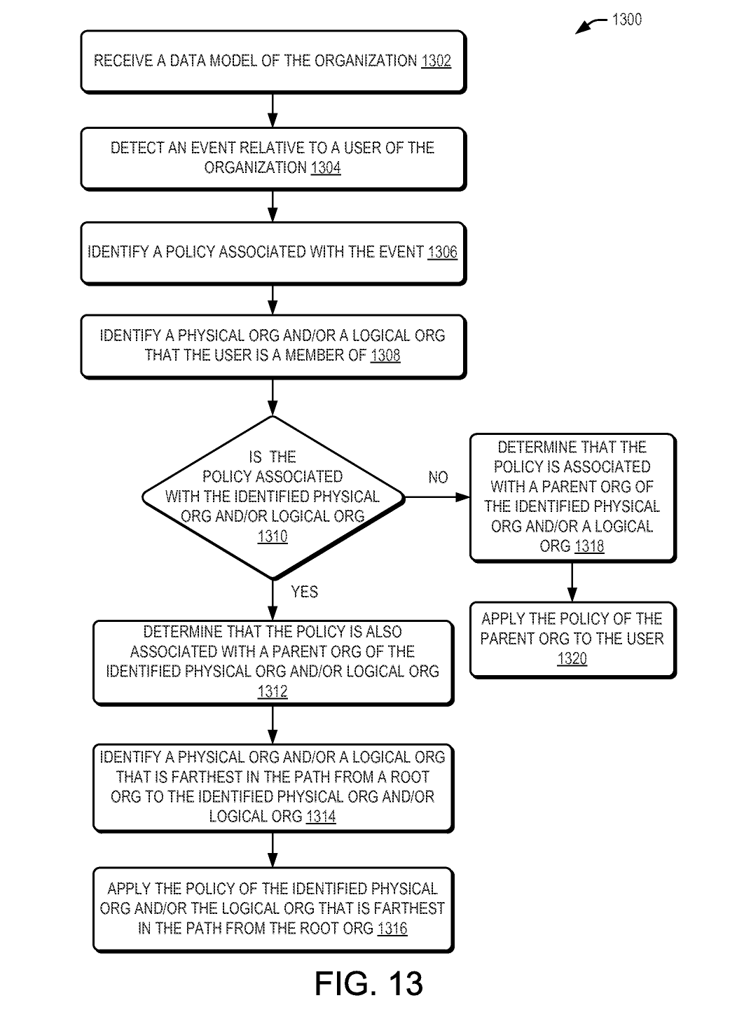

FIG. 13 is a high level flowchart depicting a process 1300 for identifying policies to be applied to users of an organization, in accordance with one embodiment of the present disclosure. In some examples, the identity management system (e.g., utilizing at least the data reader module 334, the data modeler module 336, the policy identifier module 338 and the data stores 340) shown in FIG. 3 and other figures may perform the process 1300 of FIG. 13. In some examples, the process 1300 may begin at 1302 by receiving a data model of the master organization. At 1304, the process 1300 may include detecting an event relative to a user of the master organization. As an example, an event may be detected when the user changes a password that governs the users' access one or more applications within the organization. At 1306, the process 1300 may include identifying a policy (e.g., an organization specific policy) associated with the event. As an example, at 1306, the process 1300 may identify that a password policy is associated with the event.

In some examples, at 1308, the process 1300 may include identifying a physical organization and/or logical organization represented by a leaf node in the generated data model that the user is a member of. As an example, based on the illustration of FIG. 8, the process at 1308 may identify that the user is a member of the logical organization (e.g., ‘East-coast Contractors’) represented by the leaf node 818 in the hierarchical tree 810.

At 1310, the process 1300 may include determining if the identified policy (e.g., the password policy) is associated with the logical organization (i.e., East-coast Contractors'). If it is determined that the identified policy is associated with a logical organization that the user is a member of, then in some embodiments, at 1312, the process 1300 may include determining that the identified policy (e.g., the password change policy) is also associated with a parent organization of the identified logical organization. Based on the example illustrated in FIG. 8, the process 1300 may include determining that the password policy (e.g., P1) is also associated with parent node (i.e., ‘Contractors’ 816). In certain examples, at 1314, the process 1300 may then include identifying a physical and/or logical organization in the data model that is farthest in the path from the root organization. Per the example illustrated in FIG. 8, the physical and/or logical organization that the user is a member of, that is farthest in the path from the root organization (e.g., 812) is the logical organization (e.g., ‘East-coast Contractors’) represented by the leaf node 818 in the hierarchical tree 810. In some examples, at 1314, the process may include applying the policy (e.g., P1) of the logical organization (e.g., ‘East-coast Contractors’) to the user.

In some embodiments, at 1310, if it is determined that the identified policy is not associated with any physical and/or logical organization that the user is a member of, then in some embodiments, at 1312, the process 1300 may include determining that the policy (e.g., a password policy) is associated with a parent organization (e.g., ‘Contractors’ 816) of the identified physical and/or logical organization (e.g., ‘East-coast Contractors’ 818) that the user is a member of In some examples, at 1320, the process 1300 may include applying the password policy of the parent organization (e.g., ‘Contractors’ 816) to the user.

Systems depicted in some of the figures may be provided in various configurations. In some embodiments, the systems may be configured as a distributed system where one or more components of the system are distributed across one or more networks in a cloud computing system.

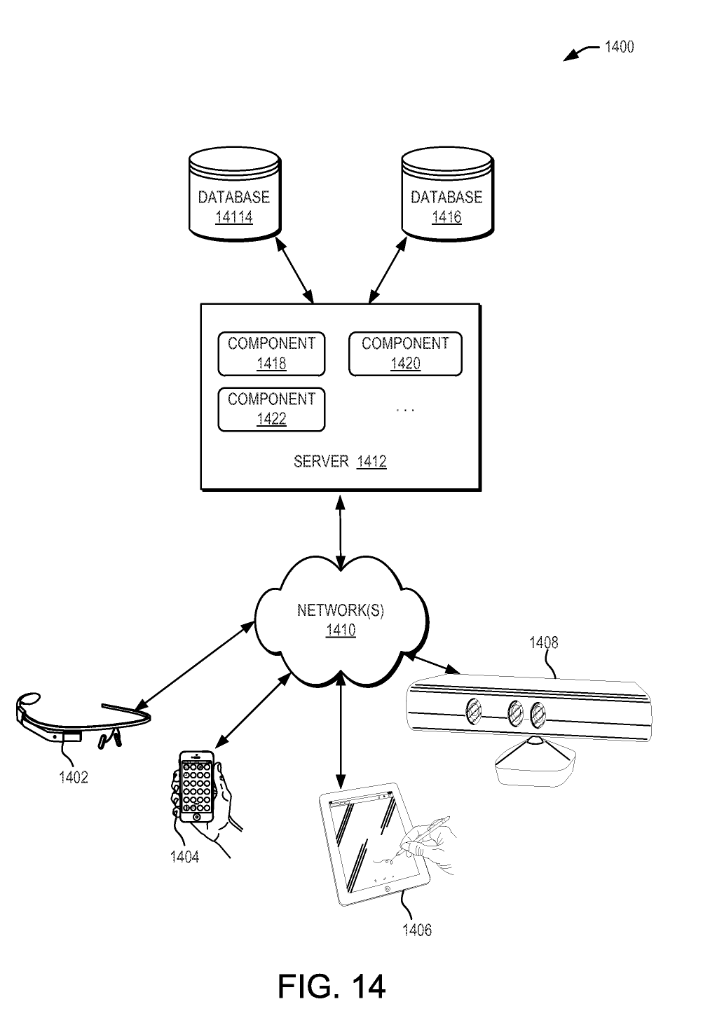

FIG. 14 depicts a simplified diagram of a distributed system 1400 for implementing an embodiment. In the illustrated embodiment, the distributed system 1400 includes one or more client computing devices 1402, 1404, 1406, and 1408, which are configured to execute and operate a client application such as a web browser, proprietary client (e.g., Oracle Forms), or the like over one or more network(s) 1410. The server 1412 may be communicatively coupled with the remote client computing devices 1402, 1404, 1406, and 1408 via network 1410.

In various embodiments, the server 1412 may be adapted to run one or more services or software applications such as services and applications that provide data management services. In certain embodiments, the server 1412 may also provide other services or software applications can include non-virtual and virtual environments. In some embodiments, these services may be offered as web-based or cloud services or under a Software as a Service (SaaS) model to the users of the client computing devices 1402, 1404, 1406, and/or 1408. Users operating the client computing devices 1402, 1404, 1406, and/or 1408 may in turn utilize one or more client applications to interact with the server 1412 to utilize the services provided by these components.

In the configuration depicted in FIG. 14, the software components 1418, 1420 and 1422 of system 1400 are shown as being implemented on the server 1412. In other embodiments, one or more of the components of the system 1400 and/or the services provided by these components may also be implemented by one or more of the client computing devices 1402, 1404, 1406, and/or 1408. Users operating the client computing devices may then utilize one or more client applications to use the services provided by these components. These components may be implemented in hardware, firmware, software, or combinations thereof. It should be appreciated that various different system configurations are possible, which may be different from distributed system 1400. The embodiment shown in FIG. 10 is thus one example of a distributed system for implementing an embodiment system and is not intended to be limiting.

The client computing devices 1402, 1404, 1406, and/or 1408 may include various types of computing systems. For example, client device may include portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like. The devices may support various applications such as various Internet-related apps, e-mail, short message service (SMS) applications, and may use various other communication protocols. The client computing devices may also include general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Client computing devices may also include electronic devices such as a thin-client computer, an Internet-enabled gaming system (e.g., a Microsoft Xbox gaming console with or without a Kinect® gesture input device), and/or a personal messaging device, capable of communicating over the network(s) 1410.

Although distributed system 1400 in FIG. 14 is shown with four client computing devices, any number of client computing devices may be supported. Other devices, such as devices with sensors, etc., may interact with the server 1412.

The network(s) 1410 in the distributed system 1400 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk, and the like. Merely by way of example, the network(s) 1410 can be a local area network (LAN), networks based on Ethernet, Token-Ring, a wide-area network, the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

The server 1412 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The server 1412 can include one or more virtual machines running virtual operating systems, or other computing architectures involving virtualization. One or more flexible pools of logical storage devices can be virtualized to maintain virtual storage devices for the server. Virtual networks can be controlled by the server 1412 using software defined networking. In various embodiments, the server 1412 may be adapted to run one or more services or software applications described in the foregoing disclosure. For example, the server 1412 may correspond to a server for performing processing as described above according to an embodiment of the present disclosure.

The server 1412 may run an operating system including any of those discussed above, as well as any commercially available server operating system. Server 1412 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, the server 1412 may include one or more applications to analyze and consolidate data feeds and/or event updates received from users of the client computing devices 1402, 1404, 1406, and 1408. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. The server 1412 may also include one or more applications to display the data feeds and/or real-time events via one or more display devices of the client computing devices 1402, 1404, 1406, and 1408.

The distributed system 1400 may also include one or more databases 1414 and 1416. These databases may provide a mechanism for storing information such as user authentication information, and other information used by embodiments of the present invention. Databases 1414 and 1416 may reside in a variety of locations. By way of example, one or more of databases 1414 and 1416 may reside on a non-transitory storage medium local to (and/or resident in) the server 1412. Alternatively, the databases 1414 and 1416 may be remote from the server 1412 and in communication with the server 1412 via a network-based or dedicated connection. In one set of embodiments, the databases 1414 and 1416 may reside in a storage-area network (SAN). Similarly, any necessary files for performing the functions attributed to the server 1412 may be stored locally on the server 1412 and/or remotely, as appropriate. In one set of embodiments, the databases 1414 and 1416 may include relational databases, such as databases provided by Oracle, that are adapted to store, update, and retrieve data in response to SQL-formatted commands.

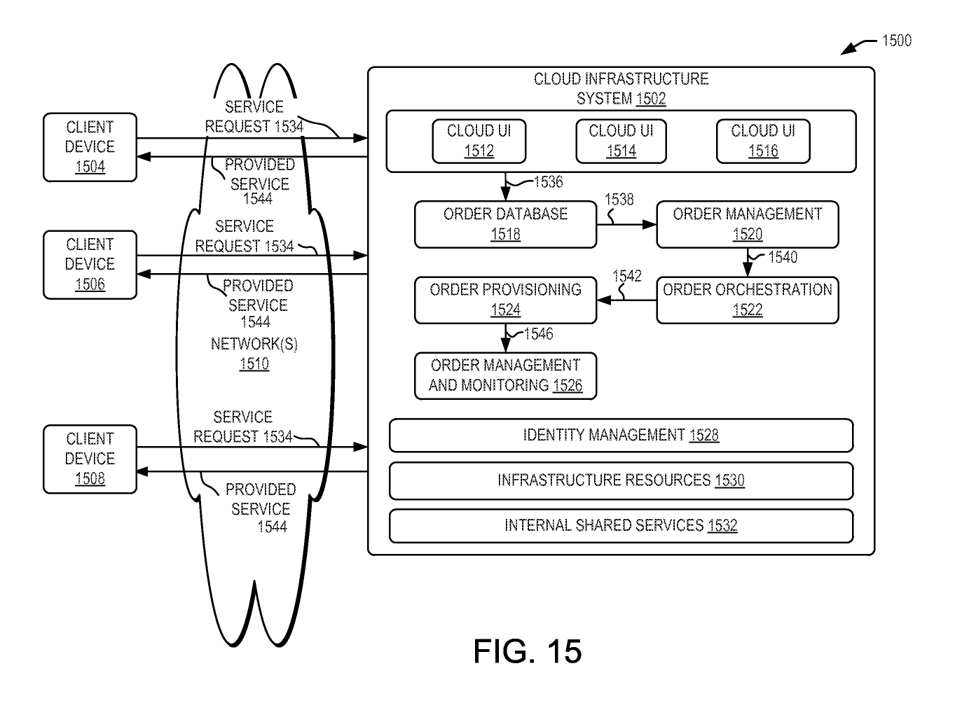

In some embodiments, the data management services described above may be offered as services via a cloud environment. FIG. 15 is a simplified block diagram of one or more components of a system environment 1500 in which services may be offered as cloud services, in accordance with an embodiment of the present disclosure. In the illustrated embodiment in FIG. 15, system environment 1500 includes one or more client computing devices 1504, 1506, and 1508 that may be used by users to interact with a cloud infrastructure system 1502 that provides cloud services, including services for managing data related to an organization. Cloud infrastructure system 1502 may comprise one or more computers and/or servers that may include those described above for server 1412.

It should be appreciated that cloud infrastructure system 1502 depicted in FIG. 15 may have other components than those depicted. Further, the embodiment shown in FIG. 15 is only one example of a cloud infrastructure system that may incorporate an embodiment of the invention. In some other embodiments, cloud infrastructure system 802 may have more or fewer components than shown in the figure, may combine two or more components, or may have a different configuration or arrangement of components.

Client computing devices 1504, 1506, and 1508 may be devices similar to those described above for 1402, 1404, 1406, and 1408. Client computing devices 1504, 1506, and 1508 may be configured to operate a client application such as a web browser, a proprietary client application (e.g., Oracle Forms), or some other application, which may be used by a user of the client computing device to interact with cloud infrastructure system 1502 to use services provided by cloud infrastructure system 1502. Although exemplary system environment 1500 is shown with three client computing devices, any number of client computing devices may be supported. Other devices such as devices with sensors, etc. may interact with cloud infrastructure system 1502.

Network(s) 1510 may facilitate communications and exchange of data between clients 1504, 1506, and 1508 and cloud infrastructure system 1502. Each network may be any type of network familiar to those skilled in the art that can support data communications using any of a variety of commercially-available protocols, including those described above for network(s) 1410.

In certain embodiments, services provided by cloud infrastructure system 1502 may include a host of services that are made available to users of the cloud infrastructure system on demand. In addition to services related to data management, various other services may also be offered including without limitation online data storage and backup solutions, Web-based e-mail services, hosted office suites and document collaboration services, database processing, managed technical support services, and the like. Services provided by the cloud infrastructure system can dynamically scale to meet the needs of its users.

In certain embodiments, a specific instantiation of a service provided by cloud infrastructure system 1502 may be referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

Cloud infrastructure system 1502 may also provide “big data” elated computation and analysis services. The term “big data” is generally used to refer to extremely large data sets that can be stored and manipulated by analysts and researchers to visualize large amounts of data, detect trends, and/or otherwise interact with the data. This big data and related applications can be hosted and/or manipulated by an infrastructure system on many levels and at different scales. Tens, hundreds, or thousands of processors linked in parallel can act upon such data in order to present it or simulate external forces on the data or what it represents. These data sets can involve structured data, such as that organized in a database or otherwise according to a structured model, and/or unstructured data (e.g., emails, images, data blobs (binary large objects), web pages, complex event processing). By leveraging an ability of an embodiment to relatively quickly focus more (or fewer) computing resources upon an objective, the cloud infrastructure system may be better available to carry out tasks on large data sets based on demand from a business, government agency, research organization, private individual, group of like-minded individuals or organizations, or other entity.

In various embodiments, cloud infrastructure system 1502 may be adapted to automatically provision, manage and track a customer's subscription to services offered by cloud infrastructure system 1502. Cloud infrastructure system 1502 may provide the cloud services via different deployment models. For example, services may be provided under a public cloud model in which cloud infrastructure system 1502 is owned by an organization selling cloud services (e.g., owned by Oracle Corporation) and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by cloud infrastructure system 1502 via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by cloud infrastructure system 1502 without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform, and other resources.

In some embodiments, resources in cloud infrastructure system 1502 may be shared by multiple users and dynamically re-allocated per demand. Additionally, resources may be allocated to users in different time zones. For example, cloud infrastructure system 1502 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1532 may be provided that are shared by different components or modules of cloud infrastructure system 1502 to enable provision of services by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1502, and the like.

In one embodiment, as depicted in FIG. 15, cloud management functionality may be provided by one or more modules, such as an order management module 1520, an order orchestration module 1522, an order provisioning module 1524, an order management and monitoring module 1526, and an identity management module 15215. These modules may include or be provided using one or more computers and/or servers, which may be general purpose computers, specialized server computers, server farms, server clusters, or any other appropriate arrangement and/or combination.

In an exemplary operation, at 1534, a customer using a client device, such as client device 1504, 1506 or 15015, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI) such as cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

At 1536, the order information received from the customer may be stored in an order database 1518. If this is a new order, a new record may be created for the order. In one embodiment, order database 1518 can be one of several databases operated by cloud infrastructure system 1518 and operated in conjunction with other system elements.

At 1538, the order information may be forwarded to an order management module 1520 that may be configured to perform billing and accounting functions related to the order, such as verifying the order, and upon verification, booking the order.

At 1540, information regarding the order may be communicated to an order orchestration module 1522 that is configured to orchestrate the provisioning of services and resources for the order placed by the customer. In some instances, order orchestration module 1522 may use the services of order provisioning module 1524 for the provisioning. In certain embodiments, order orchestration module 1522 enables the management of business processes associated with each order and applies business logic to determine whether an order should proceed to provisioning.

As shown in the embodiment depicted in FIG. 15, at 1542, upon receiving an order for a new subscription, order orchestration module 1522 sends a request to order provisioning module 1524 to allocate resources and configure resources needed to fulfill the subscription order. Order provisioning module 1524 enables the allocation of resources for the services ordered by the customer. Order provisioning module 1524 provides a level of abstraction between the cloud services provided by cloud infrastructure system 1500 and the physical implementation layer that is used to provision the resources for providing the requested services. This enables order orchestration module 1524 to be isolated from implementation details, such as whether or not services and resources are actually provisioned on the fly or pre-provisioned and only allocated/assigned upon request.

At 1544, once the services and resources are provisioned, a notification may be sent to the subscribing customers indicating that the requested service is now ready for use. In some instance, information (e.g. a link) may be sent to the customer that enables the customer to start using the requested services.

At 1546, a customer's subscription order may be managed and tracked by an order management and monitoring module 1526. In some instances, order management and monitoring module 1526 may be configured to collect usage statistics regarding a customer use of subscribed services. For example, statistics may be collected for the amount of storage used, the amount data transferred, the number of users, and the amount of system up time and system down time, and the like.

In certain embodiments, cloud infrastructure system 1500 may include an identity management module 1528 that is configured to provide identity services, such as access management and authorization services in cloud infrastructure system 1500. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified. In some embodiments, identity management module 1528 may also perform the management of data related to an organization.

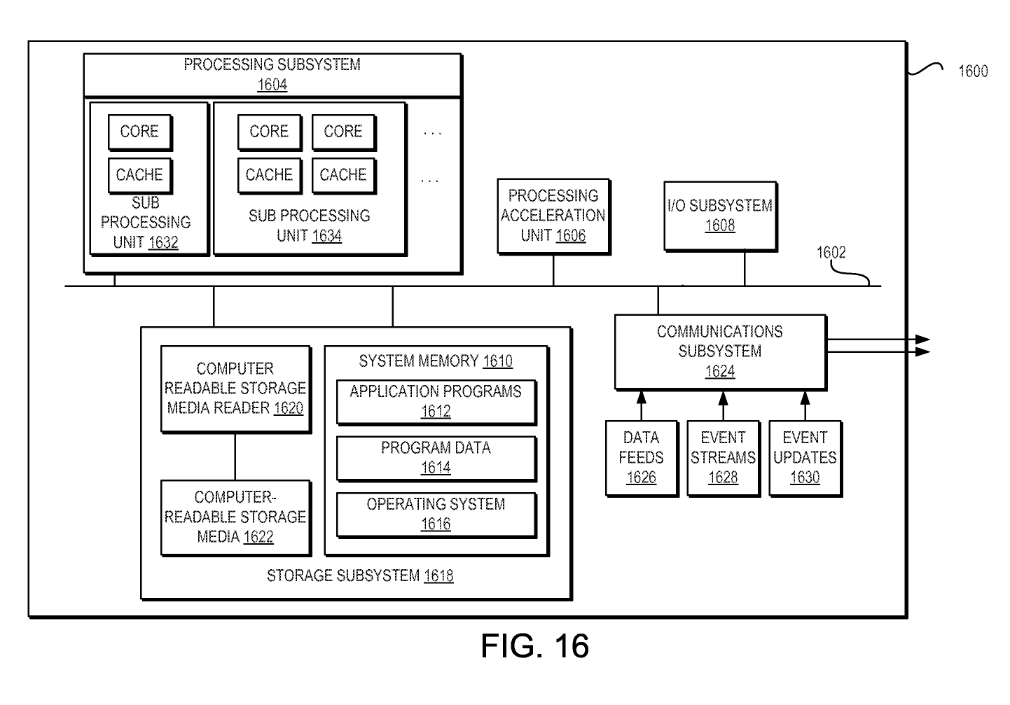

FIG. 16 illustrates an exemplary computer system 1600 that may be used to implement an embodiment of the present invention. In some embodiments, computer system 1600 may be used to implement any of the various servers and computer systems described above. As shown in FIG. 16, computer system 1600 includes various subsystems including a processing subsystem 1604 that communicates with a number of peripheral subsystems via a bus subsystem 1602. These peripheral subsystems may include a processing acceleration unit 1606, an I/O subsystem 1608, a storage subsystem 1618 and a communications subsystem 1624. Storage subsystem 1618 may include tangible computer-readable storage media 1622 and a system memory 1610.

Bus subsystem 1602 provides a mechanism for letting the various components and subsystems of computer system 1600 communicate with each other as intended. Although bus subsystem 1602 is shown schematically as a single bus, alternative embodiments of the bus subsystem may utilize multiple buses. Bus subsystem 1602 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1604 controls the operation of computer system 1600 and may comprise one or more processing units 1632, 1634, etc. A processing unit may include be one or more processors, including single core or multicore processors, one or more cores of processors, or combinations thereof. In some embodiments, processing subsystem 1604 can include one or more special purpose co-processors such as graphics processors, digital signal processors (DSPs), or the like. In some embodiments, some or all of the processing units of processing subsystem 1604 can be implemented using customized circuits, such as application specific integrated circuits (ASICs), or field programmable gate arrays (FPGAs).

In some embodiments, the processing units in processing subsystem 1604 can execute instructions stored in system memory 1610 or on computer readable storage media 1622. In various embodiments, the processing units can execute a variety of programs or code instructions and can maintain multiple concurrently executing programs or processes. At any given time, some or all of the program code to be executed can be resident in system memory 1610 and/or on computer-readable storage media 1610 including potentially on one or more storage devices. Through suitable programming, processing subsystem 1604 can provide various functionalities described above for dynamically modifying documents (e.g., webpages) responsive to usage patterns.

In certain embodiments, a processing acceleration unit 1606 may be provided for performing customized processing or for off-loading some of the processing performed by processing subsystem 1604 so as to accelerate the overall processing performed by computer system 1600.

I/O subsystem 1608 may include devices and mechanisms for inputting information to computer system 1600 and/or for outputting information from or via computer system 1600. In general, use of the term “input device” is intended to include all possible types of devices and mechanisms for inputting information to computer system 1600. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Ski® navigator), through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1600 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 1618 provides a repository or data store for storing information that is used by computer system 1600. Storage subsystem 1618 provides a tangible non-transitory computer-readable storage medium for storing the basic programming and data constructs that provide the functionality of some embodiments. Software (programs, code modules, instructions) that when executed by processing subsystem 1604 provide the functionality described above may be stored in storage subsystem 1618. The software may be executed by one or more processing units of processing subsystem 1604. Storage subsystem 1618 may also provide a repository for storing data used in accordance with the present invention.

Storage subsystem 1618 may include one or more non-transitory memory devices, including volatile and non-volatile memory devices. As shown in FIG. 16, storage subsystem 1618 includes a system memory 1610 and a computer-readable storage media 1622. System memory 1610 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1600, such as during start-up, may typically be stored in the ROM. The RAM typically contains data and/or program modules that are presently being operated and executed by processing subsystem 1604. In some implementations, system memory 1610 may include multiple different types of memory, such as static random access memory (SRAM) or dynamic random access memory (DRAM).

By way of example, and not limitation, as depicted in FIG. 16, system memory 1610 may store application programs 1612, which may include client applications, Web browsers, mid-tier applications, relational database management systems (RDBMS), etc., program data 1614, and an operating system 1616. By way of example, operating system 1616 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Computer-readable storage media 1622 may store programming and data constructs that provide the functionality of some embodiments. Software (programs, code modules, instructions) that when executed by processing subsystem 1604 a processor provide the functionality described above may be stored in storage subsystem 1618. By way of example, computer-readable storage media 1622 may include non-volatile memory such as a hard disk drive, a magnetic disk drive, an optical disk drive such as a CD ROM, DVD, a Blu-Ray® disk, or other optical media. Computer-readable storage media 1622 may include, but is not limited to, Zip® drives, flash memory cards, universal serial bus (USB) flash drives, secure digital (SD) cards, DVD disks, digital video tape, and the like. Computer-readable storage media 1622 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. Computer-readable media 1622 may provide storage of computer-readable instructions, data structures, program modules, and other data for computer system 1600.

In certain embodiments, storage subsystem 1600 may also include a computer-readable storage media reader 1620 that can further be connected to computer-readable storage media 1622. Together and, optionally, in combination with system memory 1610, computer-readable storage media 1622 may comprehensively represent remote, local, fixed, and/or removable storage devices plus storage media for storing computer-readable information.

In certain embodiments, computer system 1600 may provide support for executing one or more virtual machines. Computer system 1600 may execute a program such as a hypervisor for facilitating the configuring and managing of the virtual machines. Each virtual machine may be allocated memory, compute (e.g., processors, cores), I/O, and networking resources. Each virtual machine typically runs its own operating system, which may be the same as or different from the operating systems executed by other virtual machines executed by computer system 1600. Accordingly, multiple operating systems may potentially be run concurrently by computer system 1600. Each virtual machine generally runs independently of the other virtual machines.

Communications subsystem 1624 provides an interface to other computer systems and networks. Communications subsystem 1624 serves as an interface for receiving data from and transmitting data to other systems from computer system 1600. For example, communications subsystem 1624 may enable computer system 1600 to establish a communication channel to one or more client devices via the Internet for receiving and sending information from and to the client devices. Additionally, communication subsystem 1624 may be used to communicate notifications of successful logins or notifications to re-enter a password from the account management system 112 to the requesting users.

Communication subsystem 1624 may support both wired and/or wireless communication protocols. For example, in certain embodiments, communications subsystem 1624 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1624 can provide wired network connectivity (e.g., Ethernet) in addition to or instead of a wireless interface.

Communication subsystem 1624 can receive and transmit data in various forms. For example, in some embodiments, communications subsystem 1624 may receive input communication in the form of structured and/or unstructured data feeds 1626, event streams 1628, event updates 1630, and the like. For example, communications subsystem 1624 may be configured to receive (or send) data feeds 1626 in real-time from users of social media networks and/or other communication services such as Twitter® feeds, Facebook® updates, web feeds such as Rich Site Summary (RSS) feeds, and/or real-time updates from one or more third party information sources.

In certain embodiments, communications subsystem 1624 may be configured to receive data in the form of continuous data streams, which may include event streams 1628 of real-time events and/or event updates 1630, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1624 may also be configured to output the structured and/or unstructured data feeds 1626, event streams 1628, event updates 1630, and the like to one or more databases that may be in communication with one or more streaming data source computers coupled to computer system 1600.

Computer system 1600 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system.

Due to the ever-changing nature of computers and networks, the description of computer system 1600 depicted in FIG. 16 is intended only as a specific example. Many other configurations having more or fewer components than the system depicted in FIG. 16 are possible. Based on the disclosure and teachings provided herein, a person of ordinary skill in the art will appreciate other ways and/or methods to implement the various embodiments.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps. Various features and aspects of the above-described embodiments may be used individually or jointly.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific invention embodiments have been described, these are not intended to be limiting. Various modifications and equivalents are within the scope of the following claims.

What is claimed is:

1. A computer-implemented method comprising:
detecting, by a computer system, a first event relative to a first user;
determining, by the computer system, that the first user belongs to a first organization that is represented by a first leaf node in a hierarchical tree of nodes, based at least in part on the first event;
determining, by the computer system, that a first policy is associated with a parent node of the first leaf node;
determining, by the computer system, that a second policy is associated with the first leaf node;
in response to determining that the second policy is associated with the first leaf node, selecting, by the computer system, the second policy instead of the first policy for application to the first user; and
applying, by the computer system, the selected policy to the first user.

2. The computer-implemented method of claim 1 further comprising:
detecting, by the computer system, a second event relative to a second user;
determining, by the computer system, that the second user belongs to a second organization that is represented by a second leaf node in the hierarchical tree of nodes, based at least in part on the second event;
determining, by the computer system, that a third policy identified by the second event is associated with a parent node of the second leaf node;
in response to determining that the third policy is associated with the parent node, selecting, by the computer system, the third policy of the parent node for application to the second user; and
applying, by the computer system, the selected third policy to the second user.

3. The computer-implemented method of claim 1, wherein selecting the second policy associated with the first leaf node is based at least in part on determining that the first leaf node is farthest in a path from a root organization represented by a root node in the hierarchical tree of nodes.

4. The computer-implemented method of claim 1, further comprising determining that the second policy is identical to the first policy.

5. The computer-implemented method of claim 2, further comprising selecting the third policy of the parent node based at least in part on determining that the third policy identified by the second event is not associated with the second leaf node in the hierarchical tree of nodes.

6. The computer-implemented method of claim 1, wherein the hierarchical tree of nodes represents a data model of an organization comprising at least a first organization and a second organization.

7. The computer-implemented method of claim 1, wherein at least one of the first organization or the second organization represents a logical organization of the organization, wherein the logical organization represents a sub-organization of the organization not represented in a directory of the organization.

8. An identity management system, comprising:
a data reader configured to read data from a directory of an organization;
a data modeler configured to generate a data model of the organization based at least in part on the data, the data model comprising a hierarchical tree of nodes representing one or more entities of the organization; and
a policy identifier configured to identify a policy to be applied to a first user of the organization, the policy identifier further configured to:
detect a first event relative to the first user;
based at least in part on the first event, determine that the first user belongs to a first entity of the one or more entities of the organization, the first entity represented by a first leaf node in the hierarchical tree of nodes;
determine that a first policy is associated with a parent node of the first leaf node;
determine that the second policy is associated with the first leaf node;
in response to determining that the second policy is associated with the first leaf node, identifying the second policy instead of the first policy for application to the first user; and
applying, by the computer system, the second policy to the first user.

9. The identity management system of claim 8, wherein the data modeler is further configured to:
identify the one or more entities of the organization;
identify relationships between the one or more entities; and
generate the data model based at least in part on the identified entities and the identified relationships.

10. The identity management system of claim 9, wherein at least one of the one or more entities represents a logical organization of the organization, wherein the logical organization represents a sub-organization of the organization not represented in a directory of the organization.

11. The identity management system of claim 8, wherein the policy identifier is further configured to identify the second policy associated with the first leaf node based at least in part on determining that the first leaf node is farthest in a path from a root organization represented by a root node in the hierarchical tree of nodes.

12. The identity management system of claim 8, wherein the policy identifier is further configured to:
detect second event relative to a second user;
determine that the second user belongs to a second entity of the one or more entities represented by a second leaf node in the hierarchical tree of nodes, based at least in part on the second event;
determine that a third policy identified by the second event is associated with a parent node of the second leaf node;
in response to determining that the third policy is associated with the parent node, select the third policy of the parent node for application to the second user; and
apply the selected third policy to the second user.

13. The identity management system of claim 8, wherein the policy identifier is further configured to select the third policy of the parent node based at least in part on determining that the third policy identified by the second event is not associated with the second leaf node in the hierarchical tree of nodes.

14. The identity management system of claim 8, wherein at least one of the first policy and the second policy identify one or more organization-specific policies to be applied to the first user of the organization, based at least in part on the generated data model.

15. One or more non-transitory computer-readable media storing computer-executable instructions executable by one or more processors, the computer-executable instructions comprising:
instructions that cause the one or more processors to detect a first event relative to a first user;
instructions that cause the one or more processors to determine that the first user belongs to a first organization that is represented by a first leaf node in a hierarchical tree of nodes, based at least in part on the first event;
instructions that cause the one or more processors to determine that a first policy is associated with a parent node of the first leaf node;
instructions that cause the one or more processors to determine that a second policy is associated with the first leaf node;
in response to determining that the second policy is associated with the first leaf node, instructions that cause the one or more processors to select the second policy instead of the first policy for application to the first user; and
instructions that cause the one or more processors to apply the selected policy to the first user.

16. The computer-readable media of claim 15, the instructions further comprising instructions that cause the one or more processors to select the second policy associated with the first leaf node based at least in part on instructions to determine that the first leaf node is farthest in a path from a root organization represented by a root node in the hierarchical tree of nodes.

17. The computer-readable media of claim 15, the instructions further comprising instructions that cause the one or more processors to:
detect a second event relative to a second user;
determine that the second user belongs to a second organization that is represented by a second leaf node in the hierarchical tree of nodes, based at least in part on the second event;
determine that a third policy identified by the second event is associated with a parent node of the second leaf node;
in response to determining that the third policy is associated with the parent node, select the third policy of the parent node for application to the second user; and
apply the selected policy to the second user.

18. The computer-readable media of claim 15, the instructions further comprising instructions that cause the one or more processors to select the third policy of the parent node based at least in part on instructions to determine that the third policy identified by the second event is not associated with the second leaf node in the hierarchical tree of nodes.

19. The computer-readable media of claim 15, wherein the hierarchical tree of nodes represents a data model of an organization comprising at least a first organization and a second organization.

20. The computer-readable media of claim 15, wherein at least one of the first organization or the second organization represents a logical organization of the organization, wherein the logical organization represents a sub-organization of the organization not represented in a directory of the organization.
